(19) United States
(12) Patent Application Publication
(10) Pub. No.: US 2006/0048349 A1
(43) Pub. Date: Mar. 9, 2006

(54) Method and apparatus for a multipurpose fastener

(75) Inventor: David R. Vercauteren, Salinas, CA (US)

Correspondence Address: HEIMLICH LAW, 5952 DIAL WAY, SAN JOSE, CA, 95129, US

(73) Assignee: D.R. Vercauteren Enterprises, Salinas, CA (US)

(21) Appl. No.: 11/148,098

(22) Filed: Jun. 8, 2005

Related U.S. Application Data
(60) Provisional application No. 60/577,991, filed on Jun. 8, 2004.

(51) Int. Cl. B42F 1/08

(52) U.S. Cl. 24/547

(57) ABSTRACT

A method and apparatus for a multipurpose fastener have been disclosed.

### RELATED APPLICATION

This patent application claims priority of U.S. Provisional Application Ser. No. 60/577,991 filed Jun. 08, 2004 titled “Method and Apparatus for a Multipurpose Fastener”.

### FIELD OF THE INVENTION

The present invention pertains to fastening. More particularly, the present invention relates to a method and apparatus for a multipurpose fastener.

### BACKGROUND OF THE INVENTION

Devices, particularly fasteners are used extensively and on a daily basis.

A useful utility device, the fastener is often used in the office and home. It is used to fasten and/or connect objects together. With respect to, for example, fastening objects such as papers together, a paperclip is often used.

U.S. Pat. Nos. 5,170,535; 4,658,479; 4,458,386; 4,300,268; 1,565,501; 1,449,684; and 400,138 illustrate some prior approaches to fasteners. However, such art has certain limitations when fastening more than one sheaf (i.e. sheaves) of paper. Also some prior art approaches lack an easy motion for fastening pages. This may present a problem.

### BRIEF DESCRIPTION OF THE DRAWINGS

The invention is illustrated by way of example and not limitation in the figures of the accompanying drawings in which:

FIG. 1 illustrates one embodiment of the invention;

FIG. 2 illustrates a side view of FIG. 1;

FIG. 3 illustrates various embodiments of the invention;

FIG. 4 illustrates several embodiments of the invention showing right side views;

FIG. 5 shows one embodiment of the invention as a substantially circular loop;

FIG. 6 shows one embodiment of the invention as a substantially square with small loops at the ends;

FIG. 7 shows one embodiment of the invention as a substantially square with a hanging loop at the top and being constructed on a continuous loop;

FIG. 8, FIG. 9, and FIG. 10 show embodiments of the invention as having two connected loops;

FIG. 11, FIG. 12, FIG. 13 show various embodiments of the invention;

FIG. 14 illustrates an embodiment of the invention where part of the loops are on top of each other;

FIG. 15 is the side view of FIG. 14; and

FIG. 16A is a front view of one embodiment of the invention, and FIG. 16B is a side view with the “legs” of FIG. 16A expanded to show the relative placement.

### DETAILED DESCRIPTION

The invention, as exemplified in various embodiments, illustrates a method and apparatus for a multipurpose fastener.

In one embodiment of the present invention it may be used to prioritize objects keeping the process of prioritizing at the “ready”, or as a management tool to keep things well organized. The invention may also be used for organizing sheaves of paper, CDs, DVDs, cover sheets, lists, etc. It may be used in the work place, home, factory, etc.

In one embodiment of the invention, it is made of spring-like material(s), such as, but not limited to, wire, plastic, etc.

In one embodiment of the invention, the multipurpose fastener does not readily catch, mutilate, or tear paper. In one embodiment of the invention, the multipurpose fastener is fabricated to be on a single plane and is unlikely to tangle with other fasteners in box. In one embodiment of the invention, the multipurpose fastener can hold a thick set of paper. In one embodiment of the invention, the multipurpose fastener holds paper securely together. In one embodiment of the invention, the multipurpose fastener is easy to insert onto paper, is lightweight, is inexpensive, etc.

In one embodiment of the invention, the multipurpose fastener is a single object, made with a single wire or spring-like material, and developed into two gripping fasteners. The fasteners lay flat on a single plane or arch, one inside the other until used or may also have multiple planes. For example, a sheaf of paper can securely fit into the larger fastener (loop) first and the additional fastener will be on the top of the sheaf of paper which is about half as long. The top of both fasteners are close to the top of the multipurpose fastener, so that when both fasteners are used, the top edges meet closely.

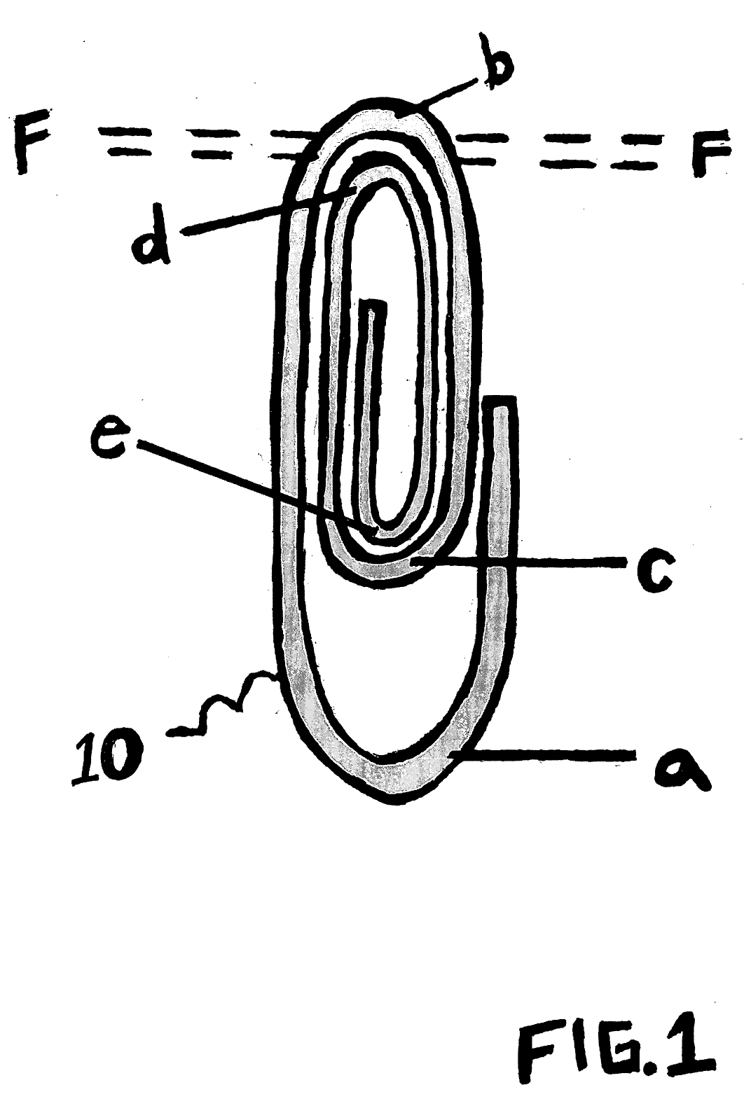

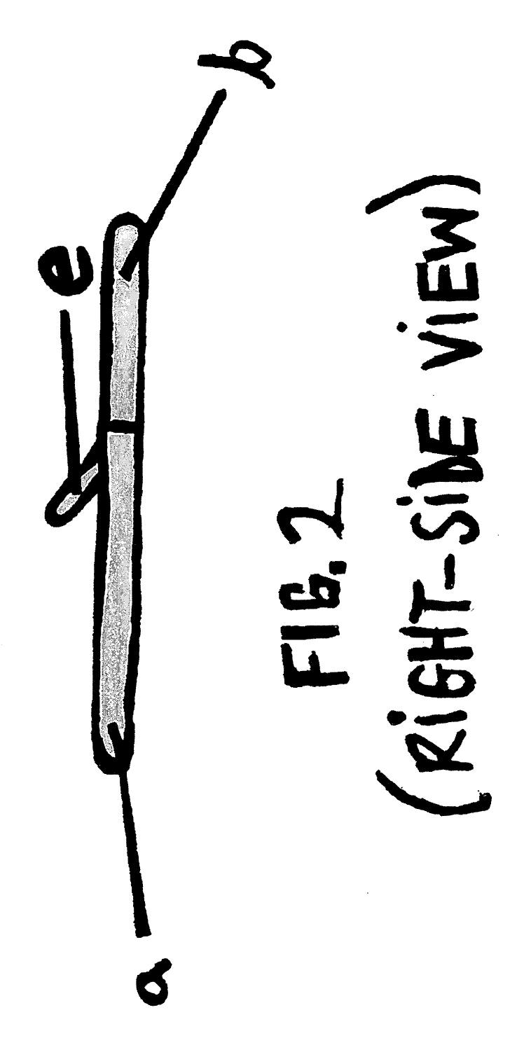

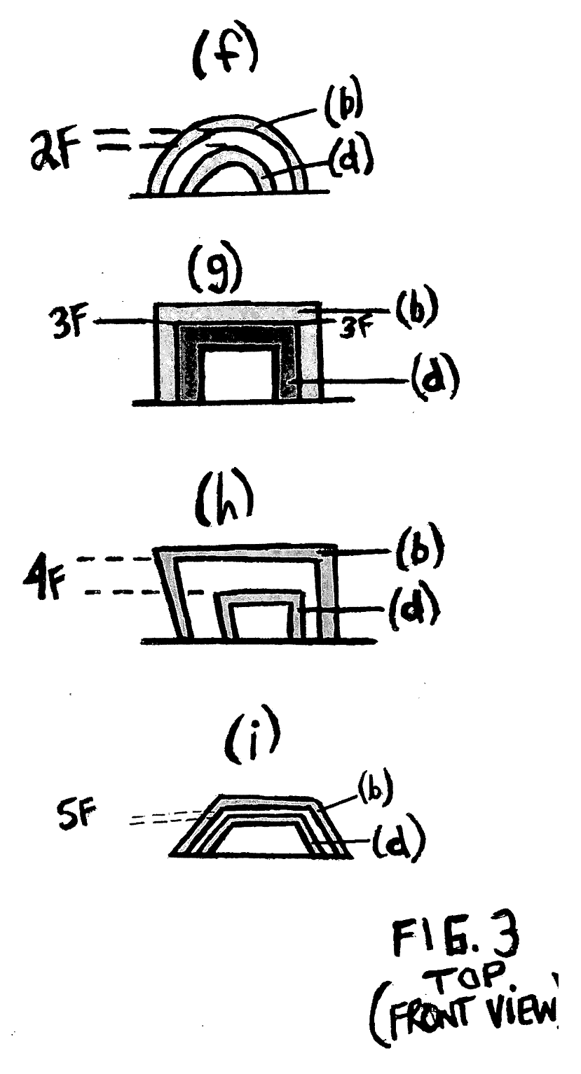

FIG. 1 illustrates one embodiment of the invention. FIG. 2 illustrates a side view of FIG. 1. The Multipurpose Fastener is a length of stiff-like wire, bent into five nested loops (FIG. 1) with loop (e) bent up at an angle (FIG. 2). Both the large fastener (between loops (a) and (c)) and the additional smaller clip (between loops (c) and (e)) hold paper together when inserted between loops.

The first loop (a) is U-shaped and turns to the left that starts from the outermost edges of (10). The second loop (b) is also U-shaped and turns to the right and loops slightly inside of where the wire began. The third loop (c) is also U-shaped and turns to the left, about half the length of loop (a). The fourth loop (d) bends right and fits along with loop (b) in a U-shape. The last loop (e) bends left, but now the U-shape is bent upwards at an angle (FIG. 2). The wire ends between loops (d) and (e).

The wire in each inner loop runs parallel to the outer loop that bends to make the fastener. All loops are on a single plane or arch, except for loop (e), breaking the plane, bent upwards at an angle. After pushing objects between loops (a) and (c), the remaining fastener between loops (c) and (e) is the extension where one can insert more objects, breaking the single plane or arch, deforming the fastener for use. The device has two fasteners, acting as springs and squeezes the sheets together, securing objects. Loop (d) should bend closely or touch loop (b) on a single plane, to avoid damage to objects and to secure objects at the top (F), otherwise making objects uneven and may cause damage to objects when applying.

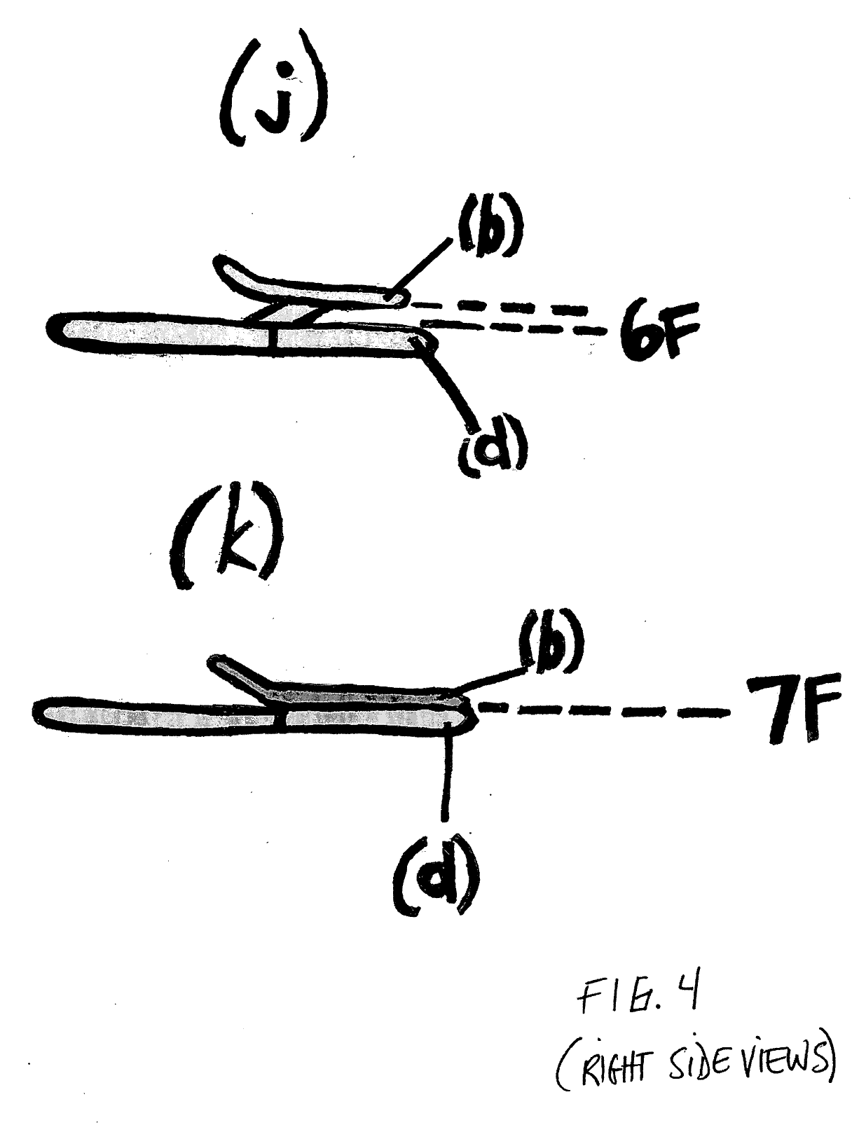

One of skill in the art will note that in the present invention several of the loops are closely spaced. This allows for papers to be fastened substantially even with the top of other papers. This feature is also shown in FIG. 3 showing other embodiments of the invention. In FIG. 3(f), 2F for example, illustrates how (b) runs closely to (d). In FIG. 3(g), 3F for example, illustrates how (b) and (d) are touching. In FIG. 3(h), 4F for example, illustrates how (b) and (d) are wider, however still close enough to keep objects secured near the top of (b). In FIG. 3(i), 5F is showing (b) and (d) are close together on a single plane.

FIG. 4 illustrates several embodiments of the invention showing right side views. FIG. 4(j) shows 6F as the close distance between (b) and (d). FIG. 4(k) shows 7F where (b) and (d) are in contact.

One of skill in the art will appreciate that there are different variations to this invention that will deal with similar principles such as different colors, sizes, shapes, materials, gauges of wire, coatings, textures, the mirror image (looping in opposite direction), etc.

One of skill in the art will appreciate that more loops may be added to hold additional groups of pages, that other shapes are possible, etc.

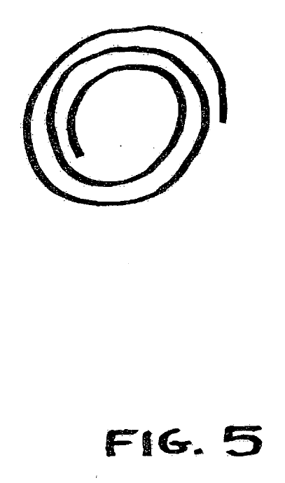

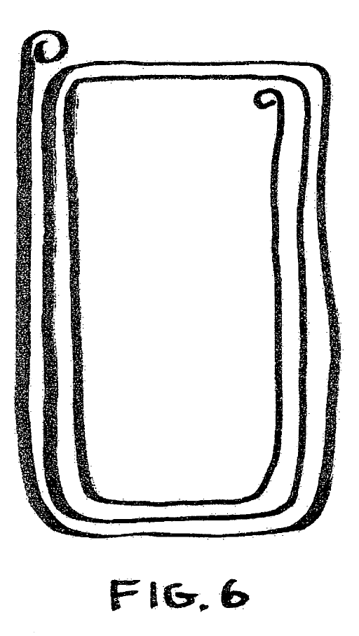

For example, FIG. 5 shows one embodiment of the invention as a substantially circular loop.

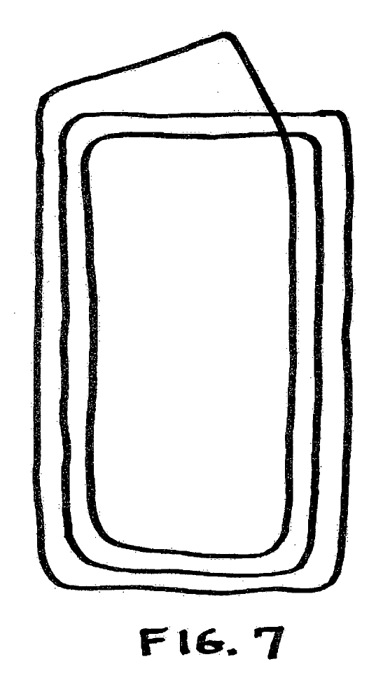

FIG. 6 shows one embodiment of the invention as a substantially square with small loops at the ends. Such loops would be used to fasten the clip (and any pages) to, for example, a cork board.

FIG. 7 shows one embodiment of the invention as a substantially square with a hanging loop at the top and being constructed on a continuous loop.

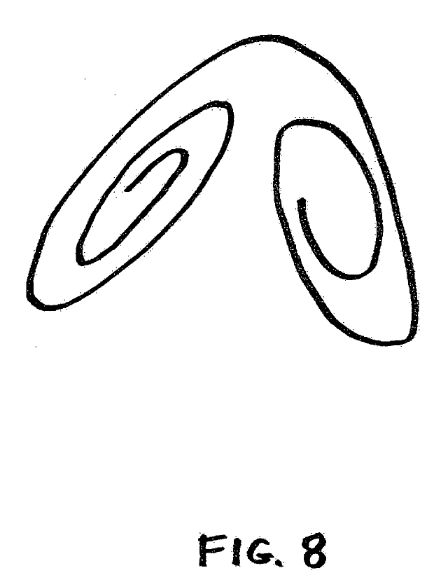

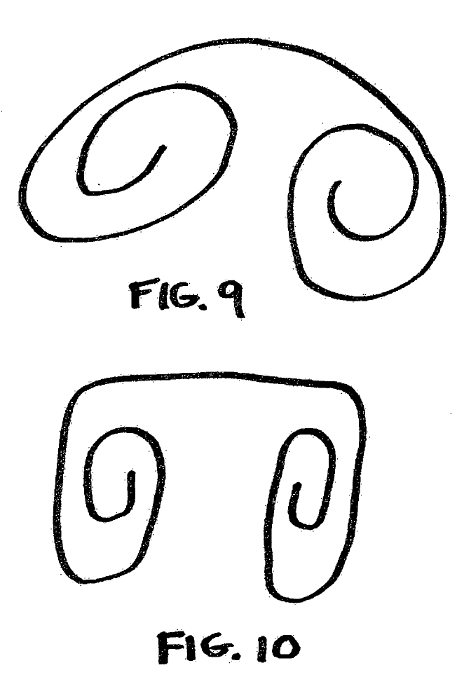

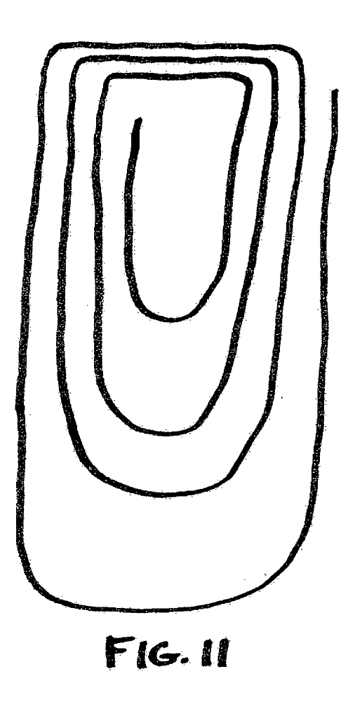

FIG. 8, FIG. 9, and FIG. 10 show embodiments of the invention as having two connected loops.

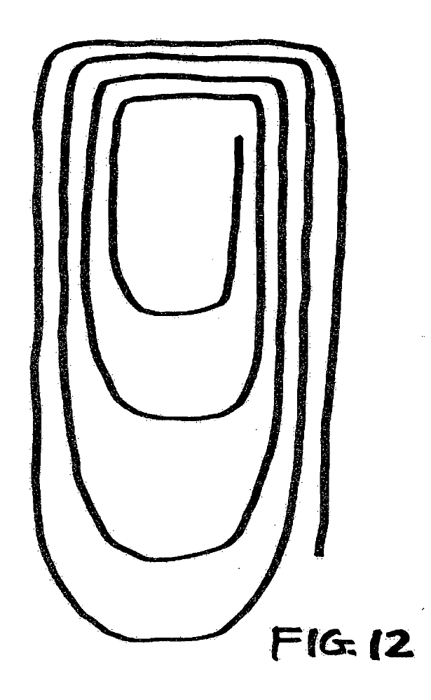

FIG. 11, FIG. 12, FIG. 13 show various embodiments of the invention.

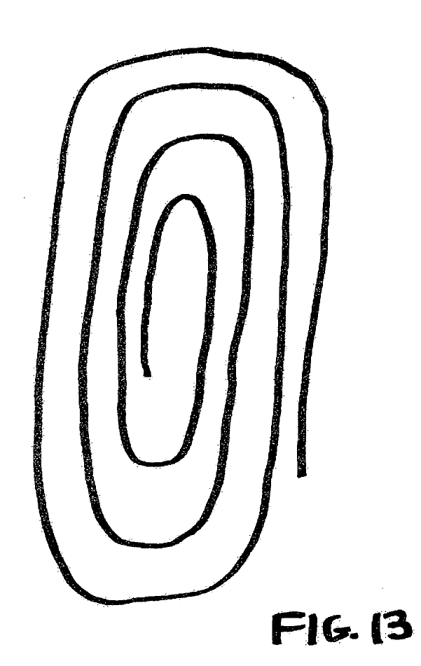

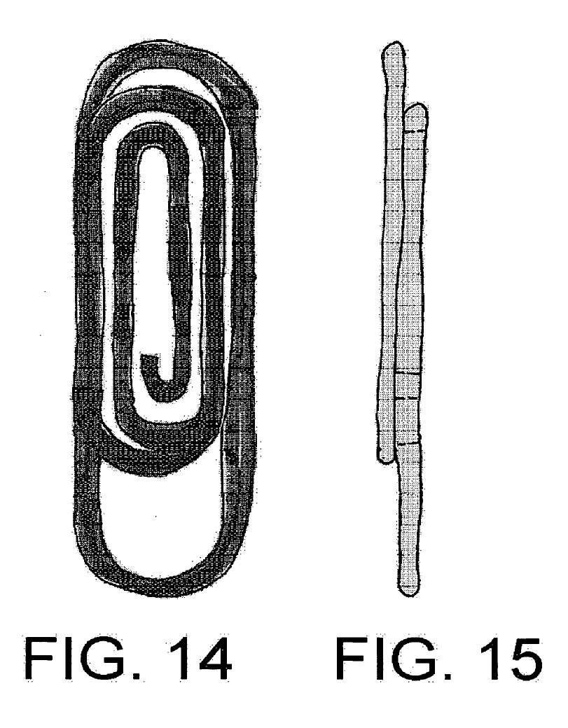

FIG. 14 illustrates an embodiment of the invention where part of the loops are on top of each other as shown FIG. 15 which is the side view of FIG. 14.

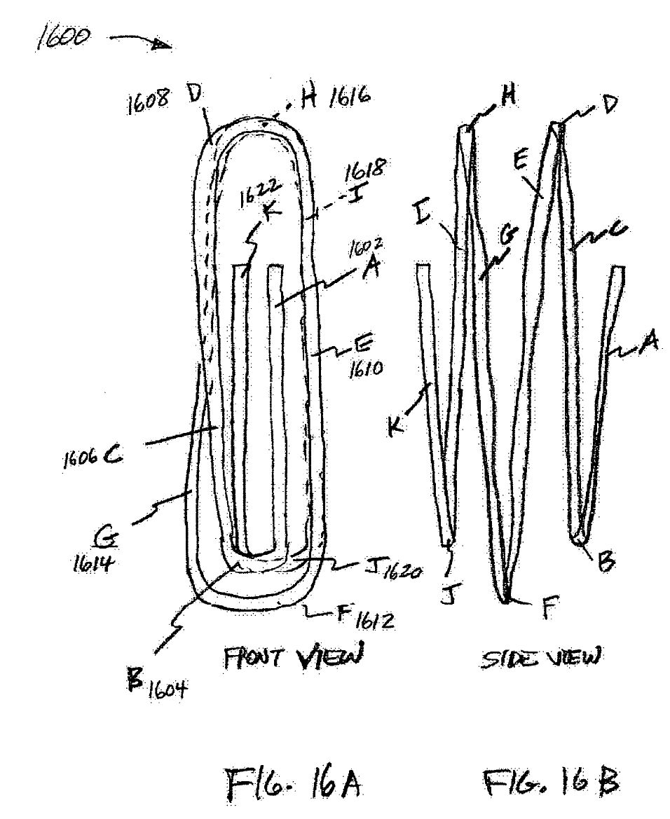

FIG. 16A is a front view of one embodiment of the invention, and FIG. 16B is a side view with the “legs” of FIG. 16A expanded to show the relative placement. The legs are not normally expanded and would be in close proximity with each other. FIG. 16 illustrates one embodiment 1600 of the invention. A (a) a first leg A 1602 extending a first distance in a first direction from one end of the resilient material; connecting with (b) a first generally arcuate portion B 1604 extending from said first leg; connecting with (c) a second leg C 1606 extending from said first generally arcuate portion a second distance in a second direction substantially parallel and opposite said first direction; connecting with (d) a second generally arcuate portion D 1608 extending from said second leg; connecting with (e) a third leg E 1610 extending from said second generally arcuate portion a third distance in a third direction substantially parallel with and in the same direction as said first direction; connecting with (f) a third generally arcuate portion F 1612 extending from said third leg; connecting with (g) a fourth leg G 1614 extending from said third generally arcuate portion a fourth distance in a fourth direction substantially parallel and in the same direction as said second direction; connecting with (h) a fourth generally arcuate portion H 1616 extending from said fourth leg; connecting with (i) a fifth leg I 1618 extending from said fourth generally arcuate portion a fifth distance in a fifth direction substantially parallel with and in the same direction as said third direction; connecting with (j) a fifth generally arcuate portion J 1620 extending from said fifth leg; and connecting with (k) a sixth leg K 1622 extending from said fifth generally arcuate portion a sixth distance in a sixth direction substantially parallel and in the same direction as said fourth direction.

One of skill in the art will appreciate that in FIG. 16A and FIG. 16B a first sheaf of paper(s) may be grasped between loops A-B-C and E-F-G, and that a second sheaf of paper(s) may be grasped between loops K-J-I and G-F-E.

Additionally, for added holding power a single sheaf of papers may be grasped by between loop E-F-G and two loops A-B-C and l-J-K by distorting the paper-clip so that, for example, loop E-F-G is in the background and loops A-B-C and I-J-K are in the foreground. This involves mainly moving loop I-J-K to the foreground (toward loop A-B-C).

The present invention may be fabricated by forming wire, molding plastic, etc. For example, this invention can be made using engineering tools and programs (such as AutoCAD) that transfers calculations to wire forming machines.

Thus a method and apparatus for a multipurpose fastener have been described.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a multipurpose fastener have been described.

What is claimed is:

1. A paper clip device formed from a single continuous length of multiply bent resilient material to define a plurality of loops, the device comprising:
(a) a first leg A extending a first distance in a first direction from one end of the resilient material;
(b) a first generally arcuate portion B extending from said first leg;
(c) a second leg C extending from said first generally arcuate portion a second distance in a second direction substantially parallel and opposite said first direction;
(d) a second generally arcuate portion D extending from said second leg;
(e) a third leg E extending from said second generally arcuate portion a third distance in a third direction substantially parallel with and in the same direction as said first direction;
(f) a third generally arcuate portion F extending from said third leg;
(g) a fourth leg G extending from said third generally arcuate portion a fourth distance in a fourth direction substantially parallel and in the same direction as said second direction;
(h) a fourth generally arcuate portion H extending from said fourth leg;
(i) a fifth leg I extending from said fourth generally arcuate portion a fifth distance in a fifth direction substantially parallel with and in the same direction as said third direction;
(j) a fifth generally arcuate portion J extending from said fifth leg; and
(k) a sixth leg K extending from said fifth generally arcuate portion a sixth distance in a sixth direction substantially parallel and in the same direction as said fourth direction.

2. The paper clip device of claim 1 wherein said single continuous length of multiply bent resilient material is selected from the group consisting of wire, plastic coated wire, and plastic.

3. A paper clip device formed from a single continuous length of multiply bent resilient material to define a plurality of loops, the device comprising:
(a) means for forming a first leg A extending a first distance in a first direction from one end of the resilient material;
(b) means for forming a first generally arcuate portion B extending from said first leg;
(c) means for forming a second leg C extending from said first generally arcuate portion a second distance in a second direction substantially parallel and opposite said first direction;
(d) means for forming a second generally arcuate portion D extending from said second leg;
(e) means for forming a third leg E extending from said second generally arcuate portion a third distance in a third direction substantially parallel with and in the same direction as said first direction;
(f) means for forming a third generally arcuate portion F extending from said third leg;
(g) means for forming a fourth leg G extending from said third generally arcuate portion a fourth distance in a fourth direction substantially parallel and in the same direction as said second direction;
(h) means for forming a fourth generally arcuate portion H extending from said fourth leg;
(i) means for forming a fifth leg I extending from said fourth generally arcuate portion a fifth distance in a fifth direction substantially parallel with and in the same direction as said third direction;
(j) means for forming a fifth generally arcuate portion J extending from said fifth leg; and
(k) means for forming a sixth leg K extending from said fifth generally arcuate portion a sixth distance in a sixth direction substantially parallel and in the same direction as said fourth direction.

4. A method for forming a paper clip device from a single continuous length of multiply bent resilient material to define a plurality of loops, the method comprising:
(a) forming a first leg A extending a first distance in a first direction from one end of the resilient material;
(b) forming a first generally arcuate portion B extending from said first leg;
(c) forming a second leg C extending from said first generally arcuate portion a second distance in a second direction substantially parallel and opposite said first direction;
(d) forming a second generally arcuate portion D extending from said second leg;
(e) forming a third leg E extending from said second generally arcuate portion a third distance in a third direction substantially parallel with and in the same direction as said first direction;
(f) forming a third generally arcuate portion F extending from said third leg;
(g) forming a fourth leg G extending from said third generally arcuate portion a fourth distance in a fourth direction substantially parallel and in the same direction as said second direction;
(h) forming a fourth generally arcuate portion H extending from said fourth leg;
(i) forming a fifth leg I extending from said fourth generally arcuate portion a fifth distance in a fifth direction substantially parallel with and in the same direction as said third direction;
(j) forming a fifth generally arcuate portion J extending from said fifth leg; and
(k) forming a sixth leg K extending from said fifth generally arcuate portion a sixth distance in a sixth direction substantially parallel and in the same direction as said fourth direction.
